(19) United States
(12) Patent Application Publication
(10) Pub. No.: US 2006/0231119 A1
(43) Pub. Date: Oct. 19, 2006

(54) Apparatus and method for cleaning a substrate

(76) Inventor: Han-Jung Yi, Gyeonggi-do (KR)

Correspondence Address: MARGER JOHNSON & MCCOLLOM, P.C., 210 SW MORRISON STREET, SUITE 400, PORTLAND, OR, 97204, US

(21) Appl. No.: 11/400,575

(22) Filed: Apr. 7, 2006

(30) Foreign Application Priority Data
Apr. 13, 2005 (KR) 2005-30805

(51) Int. Cl. B08B 3/12; B08B 6/00

(52) U.S. Cl. 134/1; 134/184

(57) ABSTRACT

An apparatus and method for cleaning a wafer are provided. According to various embodiments, deionized water can be activated by forming an electric field in a supply member through which the deionized water is supplied. The activated deionized water preferably contains radicals with excellent reactivity, in addition to ions. The activated deionized water is then preferably supplied to the cleaning chamber shortly after being activated, to thereby remove contaminants from the wafer. The activated deionized water can be used instead of or in addition to a chemical solution to clean the wafer. When used instead of a chemical solution, a rinsing process for removing the chemical solution from the wafer can be avoided and the costs and time associated with the cleaning process can be reduced.

### CROSS-REFERENCE TO RELATED APPLICATIONS

This U.S. non-provisional patent application claims priority under 35 U.S.C. § 119 from Korean Patent Application 2005-30805, filed on Apr. 13, 2005, the contents of which are hereby incorporated by reference in their entirety.

### BACKGROUND

1. Field of the Invention

The present invention relates to semiconductor substrate processing equipment and methods, and more particularly, to an apparatus and method for cleaning a semiconductor substrate.

2. Description of the Related Art

Conventionally, semiconductor devices are typically fabricated by repeating various unit processes, such as deposition, photolithography, etching, polishing, and cleaning. During fabrication, the cleaning process is performed to remove residual chemicals, small particles, and contaminants, which are attached on the surface of a semiconductor wafer. The cleaning process may also be used to remove unnecessary layers. Recently, as patterns are becoming more finely formed on a wafer, the importance of the cleaning process is also significantly increasing.

The cleaning process conventionally includes a chemical-solution treatment process, a rinsing process, and a drying process. The chemical-solution treatment process generally uses a chemical solution to etch or strip contaminants, such as metallic contaminants, particles and organic matter, from the wafer through a chemical reaction. After the chemical-solution treatment process is performed, the rinsing process is performed by rinsing the wafer using deionized water. The drying process is then performed to remove the deionized water from the wafer.

In order to remove the contaminants from the wafer during the chemical-solution treatment process, a cleaning solution is prepared by dissolving a chemical solution, such as ammonium hydroxide, fluoric acid, and sulfuric acid, in deionized water. The cleaning of the wafer is achieved by active species, such as hydroxyl ions, hydrogen ions, oxygen ions, and ozone ions. Among these active species, hydroxyl ions have the primary influence on the cleaning of the wafer, while the influence of hydrogen ions, oxygen ions, and ozone ions generally depends on the kinds of contaminants being removed.

Unfortunately, during the cleaning process, basic layers aside from the cleaning target may be etched by by-products other than the active species in the chemical solution,. In addition, the environment may be polluted by the use of the chemical solution. Furthermore, the purchase of expensive chemical solutions and the proper disposal of those chemical solutions can be costly.

It is desirable for the cleaning solution to contain a large amount of active species in order to improving cleaning efficiency. To increase the amount of active species, conventional cleaning methods may heat the cleaning solution to high temperature or increase the concentration of the chemical solution. Each of these approaches has severe drawbacks, however. In the case of heating the cleaning solution, for example, it takes a long time to heat the cleaning solution and it may be difficult to keep the cleaning solution hot. Also, because heating components are required, maintenance becomes more difficult and costly. In the case of increasing the concentration of the chemical solution, the basic layers aside from the cleaning target are more rapidly etched due to the increase in by-products. Accordingly, the cleaning time cannot be lengthened without the risk of undesirable side effects and it may be difficult to achieve a satisfactory cleaning.

In addition, it is desirable to combine hydrogen on the surface of the completely cleaned wafer in order to prevent the formation of a natural oxide layer when the wafer is exposed to air. Typically, when the wafer is cleaned with deionized water after the wafer is rinsed in the chemical solution (e.g., fluoric acid), fluorine combined on the wafer during the chemical-solution treatment process is replaced by hydrogen. Unfortunately, however, since in the conventional process the fluorine is mainly replaced by hydrogen ions, the replacement rate is low. Consequently, even after the wafer is cleaned, a large amount of fluorine will likely remain in the combined state on the surface of the wafer.

Furthermore, when the wafer is cleaned using the chemical solution, a rinsing process must also be performed to remove the chemical solution from the wafer. As a result, a number of processes, including the chemical-solution treatment process, the rinsing process, and the drying process, are required to clean the wafer. Because each of these processes takes time, the more processes that need to be performed, the longer it takes to clean the wafer. The conventional cleaning process is therefore longer than desirable.

It would be desirable to have an improved cleaning apparatus and method providing a reduced cleaning time and a more effective cleaning process.

### SUMMARY

According to various principles and aspects of the present invention, an improved apparatus and method for cleaning a substrate solves the problems occurring in a conventional cleaning process by reducing the time required for the cleaning process and by improving the effectiveness of a cleaning solution. According to one aspect of the present invention, an apparatus and method for treating a substrate provides an increased amount and improved type of active species contained in a cleaning solution.

According to another aspect of the present invention, an apparatus and method for treating a substrate is preferably capable of improving the hydrogen bond state of the wafer surface following a chemical-solution treatment process and a rinsing process.

According to still further aspects of the present invention, an apparatus and method for treating a substrate preferably reduces the time necessary for performing a cleaning process when compared to conventional methods.

According to yet other aspects of the present invention, an apparatus and method for treating a substrate is preferably capable of generating a large amount of various active species from a processing solution.

Various embodiments incorporating principles of the present invention provide improved apparatuses for cleaning a substrate. According to one such embodiment, the apparatus preferably includes a cleaning chamber that receives one or more substrates and which performs a cleaning process on the substrate. A cleaning solution supply member is preferably arranged in communication with the cleaning chamber to supply a cleaning solution thereto. An electric-field forming member is preferably installed in the cleaning solution supply member to form an electric field through which the cleaning solution flows. As the cleaning solution flows through the electric field, the cleaning solution is activated as molecules of the cleaning solution are electrically dissociated into ions and radicals. The ions and radicals provide the active species in the cleaning solution, thereby improving the cleaning efficiency.

In certain embodiments, deionized water may be used as the cleaning solution. When the deionized water flows through the electric field, a plurality of active species, such as hydroxyl radicals and hydroxyl ions, hydrogen radicals and hydrogen ions, oxygen radicals and oxygen ions, and ozone radicals and ozone ions, are generated from the deionized water. Due to the active species (primarily the hydroxyl radicals) contained in the deionized water, the contaminants attached to the substrate are removed.

In other embodiments, hydrogen (H₂) and oxygen (O₂) may be dissolved in the deionized water. By dissolving H₂ and O₂ in the deionized water, a large number of active species (including ions and radicals) can be generated and contained in the deionized water to effectively remove the contaminants from the substrate. The number and type of active species to be generated can be determined based on an amount of contaminants to be removed. The hydrogen (H₂) and oxygen (O₂) may be dissolved in the deionized water before the deionized water is activated.

In yet other embodiments, the electric-field forming member can include a first electrode, a second electrode, and a power source. The first electrode and the second electrode are preferably spaced apart from each other such that the cleaning solution can flow in a space (or passageway) formed between the first electrode and the second electrode. The power source applies a predetermined voltage to the first electrode or the second electrode so as to form an electric field in the space. In one embodiment, for example, the first electrode may be supplied with a high pulse voltage and the second electrode may be grounded.

In further embodiments, the cleaning solution supply member can include a nozzle to supply the cleaning solution directly to the cleaning chamber and a cleaning solution supply pipe to supply the cleaning solution to the nozzle. The electric-field forming member can be installed in the cleaning solution supply pipe. In one such embodiment, the first electrode can be disposed to enclose at least a portion of the cleaning solution supply pipe, with the second electrode disposed inside the supply pipe. The cleaning solution supply pipe enclosed by the first electrode may, for example, be formed of an insulating material, and the second electrode may be surrounded by an insulator to prevent it from being exposed to the cleaning solution. The first electrode may be formed in a cylindrical shape and the second electrode may be formed in a rod shape. By using the above-described structure, the active species can be generated from the cleaning solution as the solution flows through the supply pipe. Since, in this embodiment, the active species are supplied to the cleaning chamber immediately (or very shortly) after they are generated, it is possible to prevent the active species from being recombined before they are used in the cleaning process.

In other embodiments, the electric-field forming member can be installed in the nozzle that directly supplies the cleaning solution to the cleaning chamber. In one such embodiment, the first electrode may be formed in a cylindrical shape and disposed to enclose at least a portion of the nozzle, with the second electrode formed in a rod shape and disposed inside the nozzle. Since, in this embodiment as well, the active species are generated from the cleaning solution just before they are supplied to the cleaning chamber, the recombination of the active species can be minimized.

When the cleaning chamber is constructed to perform the cleaning process on only one substrate at a time, the amount of cleaning solution required in the cleaning process is relatively small. Therefore, a single cleaning solution supply pipe (or nozzle) in which the electric-field forming member is installed may be sufficient. When the cleaning chamber is constructed to simultaneously perform the cleaning process on a plurality of substrates, however, an amount of cleaning solution required in the process is relatively large. Therefore, according to still further embodiments of the present invention, the apparatus may provide a structure capable of supplying the cleaning chamber with a large amount of cleaning solution containing the active species.

In one such embodiment, for example, the electric-field forming member can be installed in one portion of the cleaning solution supply pipe, and a buffer tank can be installed in another portion of the cleaning solution supply pipe. The buffer tank is preferably disposed between the nozzle and the electric-field forming member to temporarily store the cleaning solution containing the active species.

In other embodiments, however, the electric-field forming member may be installed in the cleaning solution supply pipe, and a plurality of cleaning solution supply pipes can be connected to the nozzle. The cleaning solution supply pipes are preferably connected in parallel.

Various principles of the present invention can also be applied to an apparatus for treating a substrate using a processing solution. In one such embodiment, the apparatus includes a processing chamber that receives at least one substrate to perform processes on the substrate. A processing solution supply member preferably supplies a processing solution to the processing chamber, while an electric-field forming member is preferably configured to activate the processing solution by forming an electric field in a passage through which the processing solution flows. The electric-field forming member can have the same structure as that described previously with respect to the other cleaning apparatus embodiments.

The processing solution supply member can include a processing solution supply pipe arranged to supply the processing solution to the processing chamber. A first electrode of the electric-field forming member may be disposed to enclose at least a portion of the processing solution supply pipe, and a second electrode may be disposed inside the processing solution supply pipe. The processing solution supply pipe may be formed of an insulating material, and the second electrode may be surrounded by an insulator. The processing solution supply member may further include a buffer tank installed in the processing solution supply pipe to store a quantity of the processing solution that has been activated by the electric-field forming member.

Still further aspects of the present invention relate to methods for cleaning a substrate. One such method includes activating a cleaning solution by forming an electric field in a passage through which the cleaning solution flows. The activated cleaning solution is then supplied to a cleaning chamber in which one or more substrates are arranged. The substrate or substrates are thereby cleaned using radicals and ions contained in the cleaning solution.

By using a cleaning solution configured according to the principles of the present invention, environmental pollution can be prevented and the costs of performing a cleaning process may be reduced. In particular, deionized water may be used to generate the active species required in the cleaning process. In order to minimize the recombination of the active species before they are supplied to the cleaning chamber, activation of the cleaning solution may be performed in a region adjacent or proximal to the cleaning chamber.

In further embodiments, a method of cleaning a substrate may include dissolving at least one of hydrogen (H₂) and oxygen (O₂) in the deionized water before activating the deionized water.

In yet further embodiments, a method of cleaning a substrate can include removing contaminants from the substrate and drying the wafer. The contaminants may, for instance, include one or more of the following: particles, organic matter, and/or metallic contaminants. The removal of the contaminants from the substrate is preferably achieved using the activated deionized water. The active species, which preferably contains both ions and radicals, may be generated by forming an electric field through which the deionized water flows before being supplied to a cleaning chamber. Since, according to various principles of this invention, the cleaning of the wafer can be achieved without using a chemical solution, the operation of rinsing the substrate with the deionized water can be eliminated. The time necessary for performing the cleaning process can thereby be dramatically reduced. In particular, the cleaning process may be reduced to two steps, namely performing a cleaning process using the activated deionized water, and then performing a drying process.

Further embodiments of the present invention provide other methods for cleaning a substrate containing additional steps. One such method includes removing contaminants from the substrate, rinsing the substrate, and drying the substrate. The removal of the contaminants from the substrate can be achieved using a chemical solution, and the rinsing of the substrate can be achieved using active species containing ions and radicals. The drying of the substrate can be achieved by various methods known to those of skill in the art. In this embodiment, the rinsing process preferably results in hydrogen being primarily combined on the surface of the substrate. Using this method, it is therefore possible to minimize the formation of a natural oxide layer on the substrate when the substrate is exposed to air.

### BRIEF DESCRIPTION OF THE DRAWINGS

The accompanying drawings are included to provide further understanding of the invention and are incorporated in and constitute a part of the disclosure. These drawings illustrate various embodiment(s) of the invention and together with the written description serve to explain the principle of the invention. Various principles, features, and advantages of the present invention will therefore be more fully explained in the following Detailed Description of the Invention, proceeding with reference to the accompanying drawings, in which:

FIG. 1 is a somewhat schematic sectional view of a cleaning apparatus according to one preferred embodiment of the present invention;

FIG. 2 is a graph illustrating the dissociation and combination of molecules that can be used to provide the active species for cleaning a semiconductor substrate according to an aspect of the present invention, and further illustrating the dissociation energy of those molecules;

FIG. 3 is a somewhat schematic perspective view illustrating one example of an electric-field forming member that may be installed in a cleaning solution supply pipe in a cleaning apparatus, such as that of FIG. 1;

FIG. 4 is a somewhat schematic sectional view taken along line I-I of FIG. 3;

FIG. 5 is a somewhat schematic sectional view taken along line II-II of FIG. 3;

FIG. 6 is a somewhat schematic sectional view of a cleaning apparatus illustrating an alternative embodiment of the present invention, representing a variation of the embodiment shown in FIG. 1;

FIG. 7 is a somewhat schematic sectional view of a nozzle capable of use in the cleaning apparatus of FIG. 6, according to yet another aspect of the present invention;

FIG. 8 is a somewhat schematic sectional view of a cleaning apparatus according to another embodiment of the present invention, representing yet another variation of the embodiment shown in FIG. 1;

FIG. 9 is a somewhat schematic sectional view of a cleaning apparatus according to a still further embodiment of the present invention;

FIGS. 10 and 11 are somewhat schematic sectional views of cleaning apparatuses according to yet other embodiments of the present invention, representing modifications of the cleaning apparatus of FIG. 9;

FIG. 12 is a schematic diagram illustrating a surface state of a wafer during a conventional cleaning process, which proceeds using general deionized water;

FIG. 13 is a schematic diagram illustrating a surface state of a wafer during a cleaning process according to another aspect of the present invention, which proceeds using deionized water containing radicals; and

FIG. 14 is a flow diagram illustrating a method of cleaning a substrate according to yet another aspect of the present invention.

### DETAILED DESCRIPTION

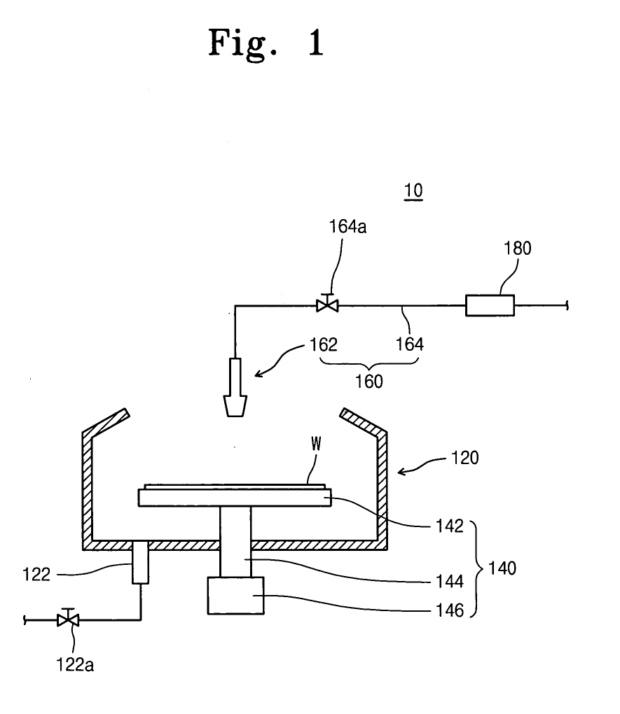

Various embodiments of the present invention will now be described more fully with reference to the accompanying FIGS. 1 through 14. It should be noted, however, that the invention may be embodied in many different forms and should not be construed as being limited to the specific embodiments set forth herein. Rather, the various embodiments are intended to provide a thorough and complete disclosure sufficient to convey the principles, concepts, and scope of the invention to those skilled in the art. In the drawings, the thicknesses of layers and regions are exaggerated for clarity. In addition, although the following description relates more particularly to an apparatus for cleaning a semiconductor substrate such as a wafer (W), the principles of the present invention can also be applied to various other kinds of apparatuses for treating a substrate using a processing solution, such as a wet etching process or other processes.

FIG. 1 is a somewhat schematic sectional view of a cleaning apparatus 10 according to a preferred embodiment of the present invention. Referring to FIG. 1, the cleaning apparatus 10 according to this embodiment is a single wafer type cleaning apparatus, wherein the cleaning process is performed with respect to one wafer W at a time. A cleaning solution is sprayed directly on the wafer W. Referring to FIG. 1, the cleaning apparatus 10 preferably includes a cleaning chamber 120, a support member 140, a cleaning solution supply member 160, and an electric-field forming member 180. The cleaning chamber 120 has an opening 124 at its top. The cleaning solution used in the process is discharged from the cleaning chamber 120 through a discharge pipe 122 with a valve 122a connected to the bottom of the cleaning chamber 120.

At least a portion of the support member 140 is disposed inside the cleaning chamber 120, and the wafer W is placed on the support member 140 during the performance of various processes. The support member 140 preferably has a support plate 142 and a rotational shaft 144. The support plate 142 preferably has a flat disc shape with a diameter similar to that of the wafer W. The wafer W is placed on the support plate 142 such that a surface to be processed faces upward. The rotational shaft 144 is connected to the bottom of the support plate 142. During the processes, the rotational shaft 144 is rotated by a driver such as a motor 146. The support plate 142 can support the wafer W, for example, by means of a vacuum or mechanical clamping. A plurality of guide pins (not shown) may be further installed at an edge of the support plate 142 to prevent the wafer W from escaping from the support plate 142 during the processes.

The cleaning solution supply member 160 supplies cleaning solution to the wafer W and preferably includes a nozzle 162 and a cleaning solution supply pipe 164. The nozzle 162 is preferably disposed above the cleaning chamber 120 to supply cleaning solution directly to the wafer W through the opening 124. The cleaning solution supply pipe 164 supplies cleaning solution from a cleaning solution container (not shown) to the nozzle 162. The nozzle 162 can supply the cleaning solution to the wafer W while moving from a center of the wafer W to an edge of the wafer W. Alternatively, the nozzle 162 can selectively supply the cleaning solution to the center of the wafer W. The cleaning solution preferably comprises deionized water.

The electric-field forming member 180 is preferably installed in the cleaning solution supply member 160 to activate the deionized water. The electric-field forming member 180 is thereby arranged to form an electric field in a passage through which the deionized water is supplied. The active species are generated from the deionized water as it passes through the electric field. More specifically, due to the electric field, water molecules are electrically dissociated into various active species. The active species can include radicals (e.g., hydroxyl radicals, hydrogen radicals, oxygen radicals, and ozone radicals) as well as ions (e.g., hydroxyl ions, hydrogen ions, oxygen ions, and ozone ions). Among these active species, the hydroxyl radicals and the hydroxyl ions are the main participants in the overall wafer cleaning process. The hydroxyl radicals in particular have good reactivity as compared to the hydroxyl ions. The hydroxyl radicals are therefore efficient in cleaning the wafer W.

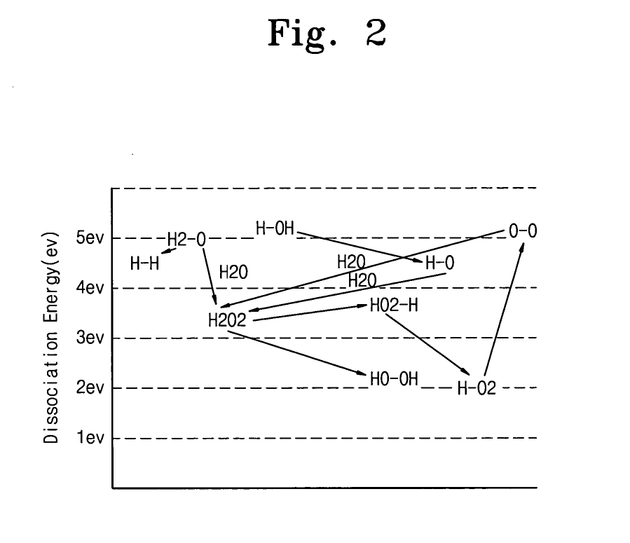

FIG. 2 is a graph illustrating the dissociation and combination of molecules that can provide the active species, along with the dissociation energy of those molecules. Referring to FIG. 2, when energy of about 5 eV is applied to a water molecule (H₂O), the water molecule is dissociated into a hydrogen molecule and an oxygen ion. The oxygen ion reacts with the water molecule to form hydrogen peroxide. When the hydrogen molecule receives energy of about 4.5 eV, it is dissociated into hydrogen ions. When the water molecule receives energy of about 5.2 eV, it is dissociated into hydrogen ions and a hydroxyl ion. The hydroxyl ion receives about 4.5 eV of energy and is dissociated into a hydrogen ion and an oxygen ion. That is, an energy level of about 5 eV or more has to be applied to electrically dissociate the water molecule.

Conventionally, in order to activate the deionized water, the deionized water may be heated to very high temperature. However, heating to a temperature of about 6000° C. provides the molecule with no more than 0.5 eV of energy. Therefore, very high temperatures are required to dissociate water molecules by heating the deionized water. However, if, according to the principles of the present invention, an electric field is formed in the passage through which the water molecule flows, very high energy can easily be supplied to the water molecule at a relatively low temperature. Also, by changing the level of energy applied to the water molecule specific desired active species can be generated.

An electrolysis method could also be used to activate the deionized water. In this method, however, hydrogen ions and hydroxyl ions are the only active species generated from the deionized water The number of different types and the overall amount of the active species generated by electrolysis are small compared with the number of types and amount of active species generated when the deionized water is activated using the electric field. Also, the electrolysis method cannot generate active species with good reactivity, such as radicals.

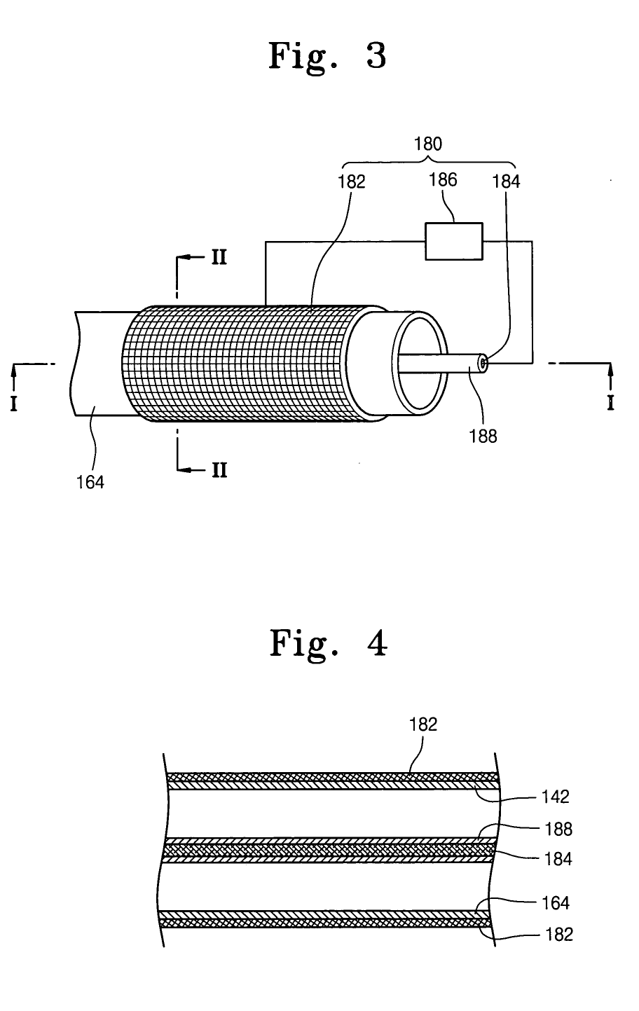

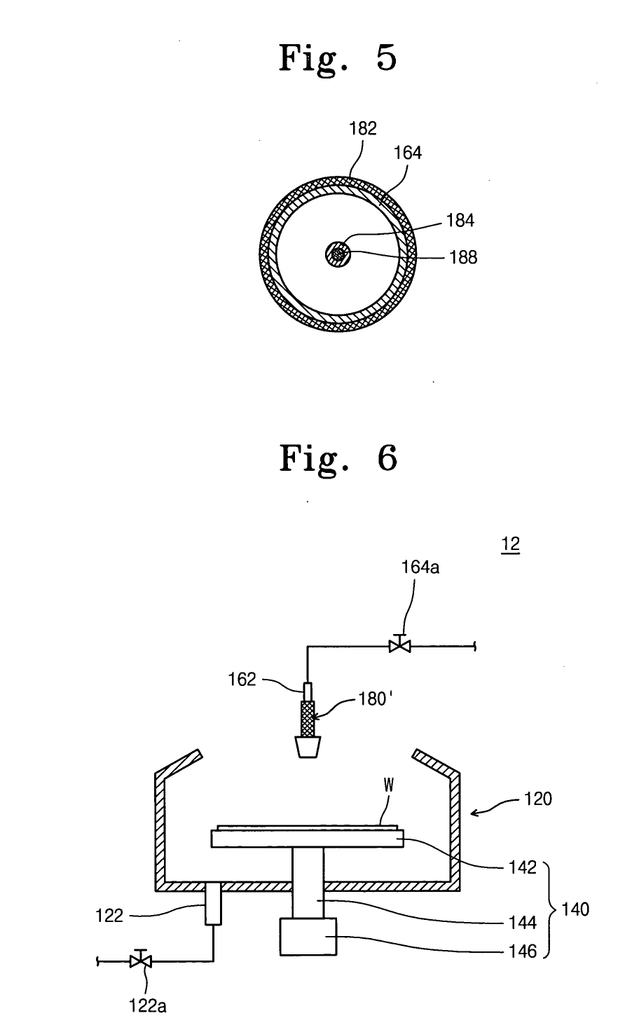

As described above, according to one embodiment of the present invention, the electric-field forming member 180 may be installed in the cleaning solution supply pipe 164. FIG. 3 is a somewhat schematic perspective view illustrating an example of the electric-field forming member 180 installed in the cleaning solution supply pipe 164. FIGS. 4 and 5 are somewhat schematic sectional views of the electric field forming member 180 of FIG. 3, taken along lines I-I and II-II, respectively. Referring to FIGS. 3 through 5, the electric-field forming member 180 preferably includes a first electrode 182, a second electrode 184, and a power source 186. The first electrode 182 may comprise a cylindrical-shaped member that encloses a portion of the cleaning solution supply pipe 164. The second electrode 184 may comprise a rod-like member inserted into the cleaning solution supply pipe 164.

The first and second electrodes 182, 184 are preferably formed of a metal such as copper. The cleaning solution supply pipe 164 is preferably formed of an insulating material. The second electrode 184 can be surrounded by an insulator 188 to prevent the electrode from being exposed to the cleaning solution. For example, the insulator 188 and the portion of the cleaning solution supply pipe 164 enclosed by the first electrode 182 may be formed of quartz. The use of insulating materials increases a threshold voltage at which a spark is generated between the first electrode 182 and the second electrode 184. Accordingly, an amount of the active species generated can increase, and the electrodes 182 and 184 can be prevented from being damaged due to reaction of the generated active species and the electrodes 182 and 184.

The power source 186 preferably supplies a predetermined voltage to either the first electrode 182 or the second electrode 184 so as to form an electric field between the first electrode 182 and the second electrode 184. For example, the first electrode 182 or the second electrode 184 can be supplied with a high pulse voltage while the other is grounded. One or more electric-field forming members 180 may be installed in the cleaning solution supply pipe 164.

When the deionized water passes through the electric field formed between the first electrode 182 and the second electrode 184, water molecules are dissociated in the deionized water and various active species of ion and radical states are generated. The deionized water containing the active species is then supplied to the nozzle 162 and sprayed toward the wafer W in the cleaning chamber 120. If the traveling path of the active species is long, the active species may be recombined before they are supplied to the wafer W. According to various principles of the present invention, however, the electric field can be formed in the path through which the deionized water is supplied to the nozzle 162. In this manner, the deionized water containing the generated active species can be directly supplied to the wafer W. Consequently, it is possible to prevent the active species contained in the cleaning solution from being recombined before the cleaning solution is supplied to the wafer W. For these reasons, it is desirable to install the electric-field forming member 180 in the cleaning solution pipe 164 at a position adjacent to the nozzle 162 (or in the nozzle 162 itself, as will be described later).

In alternative embodiments, the first and second electrodes may have a flat or curved disc shapes and be disposed facing each other. In yet another embodiment, a container having the first and second electrodes may be installed in the cleaning solution supply pipe to provide the active species.

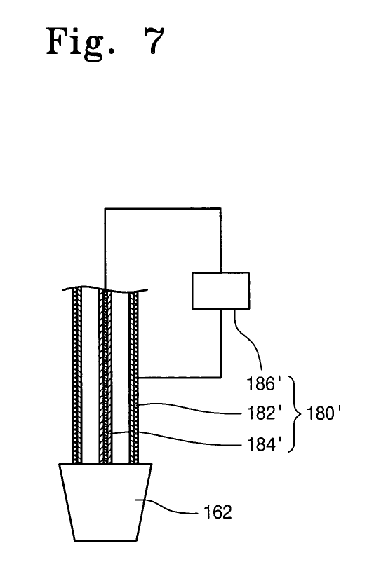

FIG. 6 is a somewhat schematic sectional view of a cleaning apparatus 12 according to an alternative embodiment of the present invention. This embodiment includes a modification to the cleaning apparatus of FIG. 1, with the electric-field forming member 180′ arranged in the nozzle 162 rather than the cleaning solution supply pipe 164. FIG. 7 is a somewhat schematic sectional view of the nozzle 162 of FIG. 6.

Referring to FIGS. 6 and 7, an electric-field forming member 180′ is installed in a nozzle 162. As in the previous embodiment, the electric-field forming member 180′ preferably includes a first electrode 182′, a second electrode 184′, and a power source 186′. The first electrode 182′ may comprise a cylindrical-shaped member that encloses the nozzle 162. The second electrode 184′ may comprise a rod-shaped member installed inside the nozzle 162. The power source 186′ supplies a predetermined voltage to the first electrode 182′ and/or second electrode 184′ so as to form an electric field therebetween. The nozzle 162 may be formed of an insulating material, and the second electrode 184′ may be surrounded by an insulator 188 such as a quartz. By providing an electric field in the nozzle, deionized water can be supplied to the wafer W just after the active species are generated. It is therefore possible to prevent the active species from being recombined while the cleaning solution is moving toward the nozzle 162.

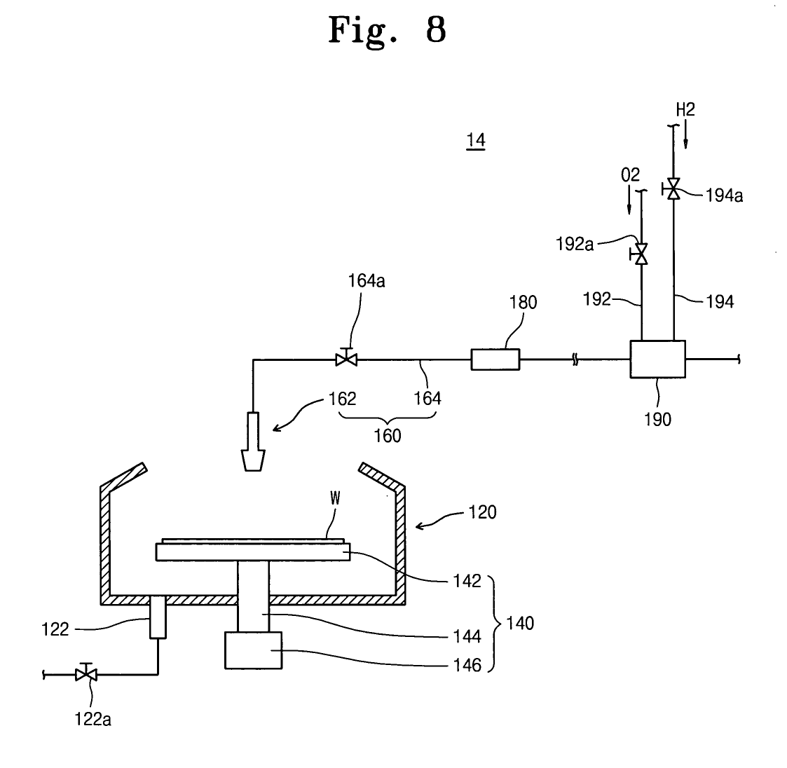

FIG. 8 is a somewhat schematic sectional view of a cleaning apparatus 14 according to yet another embodiment of the present invention. This embodiment provides another modification 14 to the cleaning apparatus of FIG. 1. Referring to FIG. 8, the cleaning apparatus 14 according to this embodiment preferably includes a mixing tank 190 in which a specific gas can be dissolved in the deionized water before the deionized water is supplied to a region where the electric field is formed. The mixing tank 190 is preferably installed in the cleaning solution supply pipe 164, and gas supply pipes 192 and 194 can be connected to the mixing tank 190. The gases dissolved in the deionized water are preferably gases that can generate active species that will react well with the specific contaminants to be removed from the wafer W.

For example, when the contaminants are organic matter, oxygen gas (O₂) is preferably supplied to the mixing tank 190 so that a substantial amount of oxygen ions and radicals and ozone ions and radicals can be generated. When the contaminants are particles or metal, however, hydrogen gas (H₂) is preferably supplied to the mixing tank 190 so that a substantial amount of hydrogen ions and radicals can be generated. An oxygen supply pipe 192 for supplying oxygen gas and a hydrogen supply pipe 194 for supplying hydrogen gas may be connected to the mixing tank 190. Valves 192a and 194a may be installed in the supply pipes 192 and 194, respectively, to control the flow of gas into the mixing tank 190. Using the valves 192 and 194, oxygen and hydrogen can be individually or simultaneously supplied to the mixing tank in various desired amounts or percentages.

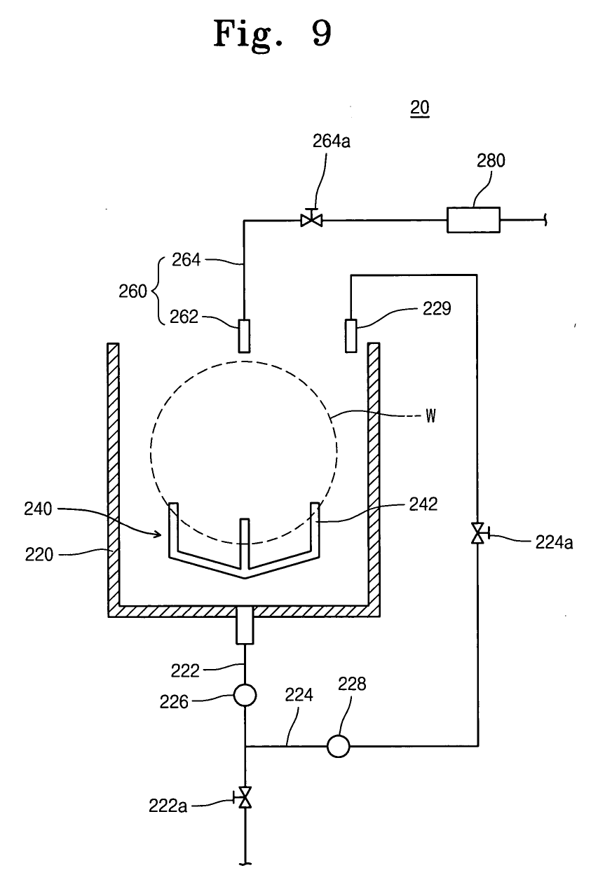

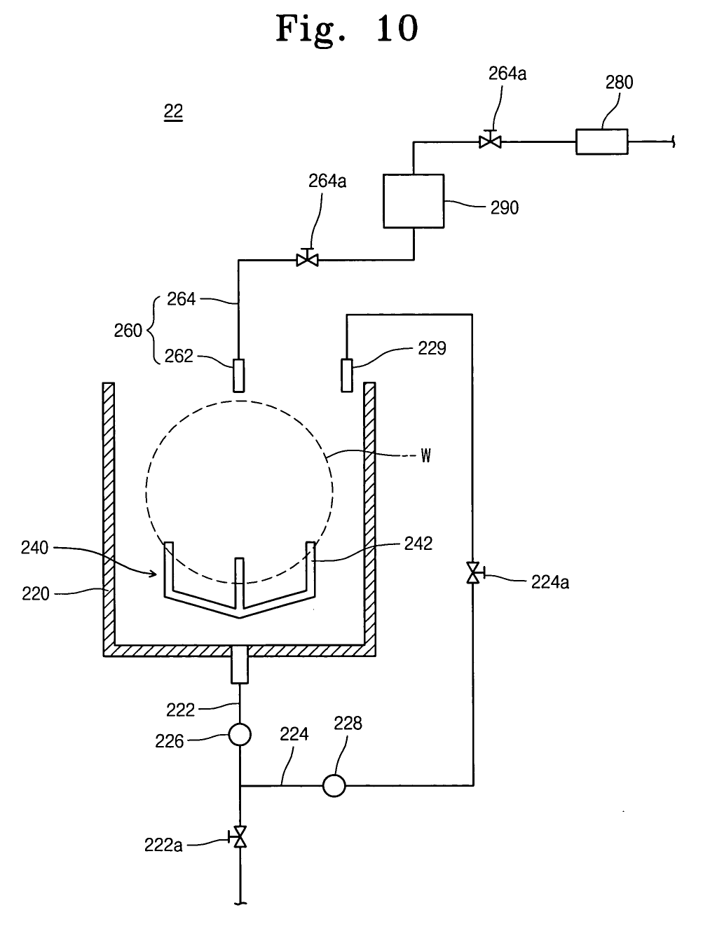

FIG. 9 is a somewhat schematic sectional view of a cleaning apparatus 20 according to yet another embodiment of the present invention. Referring to FIG. 9, the cleaning apparatus 20 of this embodiment is a batch type cleaning apparatus in which the cleaning process is simultaneously performed on a plurality of wafers W. The cleaning apparatus 20 preferably includes the cleaning chamber 220, a support member 240, a cleaning solution supply member 260, and an electric-field forming member 280. To perform the cleaning process, the wafers W are dipped into cleaning solution contained in a cleaning chamber 220. The cleaning chamber 220 may provide an approximately hexagonal space having an open top. A cover (not shown) may be provided for closing the top of the cleaning chamber 220.

To simultaneously receive a plurality of wafers W (e.g., about 50 wafers), the support member 240 may include support rods 242 with slots configured to receive an edge of each of the wafers W. Three support rods 242 may be provided. When inserted into the support member 240, the wafers W are preferably arranged upright in a row. A discharge pipe 222 is connected to the bottom of the cleaning chamber 220 to discharge the cleaning solution from the cleaning chamber 220. A collection pipe 224 is connected to the discharge pipe 222 to enable reuse of the cleaning solution. A nozzle 229 may be installed in an end of the collection pipe 224 in communication with the opening in the top of the cleaning chamber 220. The nozzle 229 can supply the recycled cleaning solution into the cleaning chamber 220. Valves 222a and 224a are preferably installed in the discharge pipe 222 and the collection pipe 224, respectively, to control the direction and flow of the discharged cleaning solution. A pump 226 may be installed to provide a forced flow pressure to the cleaning solution, and a filter 228 may be installed in the collection pipe 224 to remove foreign particles from the collected cleaning solution.

The cleaning solution supply member 260 is installed in communication with the cleaning chamber 220, and supplies the cleaning solution, such as deionized water, into the cleaning chamber 220. The electric-field forming member 280 is preferably installed in the cleaning solution supply member 260. Since the structures of the cleaning solution supply member 260 and the electric-field forming member 280 are substantially similar to those of FIG. 1, a detailed description thereof will be omitted.

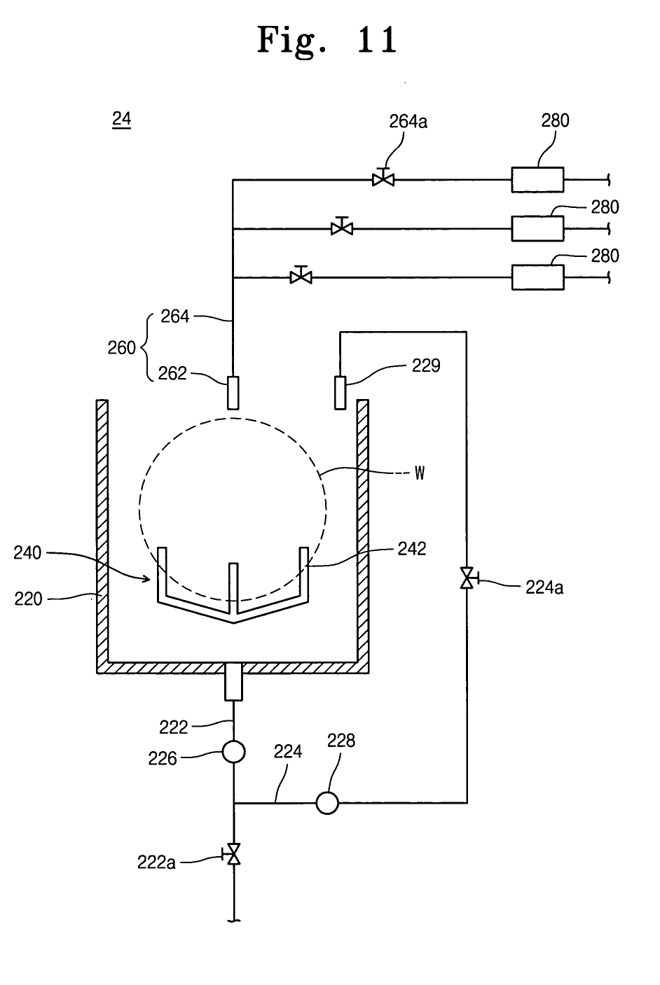

Compared with the single wafer type cleaning apparatus, the batch type cleaning apparatus requires a relatively large amount of the cleaning solution. When a large volume of deionized water flows through the cleaning solution supply pipe 264, the amount of active species generated from the deionized water relative to the amount of deionized water is small, thus degrading the cleaning efficiency. FIGS. 10 and 11 are somewhat schematic sectional views illustrating various alternative embodiments of the present invention. These alternate embodiments include certain modifications to the cleaning apparatus 20 of FIG. 9 in order to provide cleaning apparatuses 22, 24 that are better adapted to perform an effective batch type cleaning process, where a large amount of activated cleaning solution is required.

Referring to FIG. 10, a cleaning apparatus 22 according to one such embodiment preferably has a buffer tank 290 installed in the cleaning solution supply pipe 264 to store a quantity of deionized water containing active species. The buffer tank 290 is preferably disposed between the electric-field forming member 280 and the nozzle 262. In operation, the cleaning solution activated by the electric-field forming member 280 is temporarily stored in the buffer tank 290. A valve 264a can then be opened to supply the activated deionized water stored in the buffer tank 290 to the cleaning chamber 220. Through this embodiment, the cleaning apparatus 22 can easily supply a large amount of activated deionized water to the cleaning chamber 220. A more efficient batch type cleaning process can thereby be performed.

Referring to FIG. 11, a cleaning apparatus 24 according to another embodiment preferably includes a plurality of supply pipes 264 connected in parallel to a nozzle 262. A plurality of electric-field forming members 280 are installed in the cleaning solution supply pipes 264 with a plurality of valves 264a for opening/closing internal passages to direct the flow and quantity of cleaning solution. Using the structure of this embodiment, the cleaning apparatus 24 can supply a large amount of activated deionized water to the cleaning chamber 220 with a reduced chance of recombination of the active species.

Although not shown, the cleaning solution supply member 260 can include a plurality of nozzles 262. Electric-field forming members 280 may be installed in each of the respective nozzles 262, or may be installed in the cleaning solution supply pipe 264 connected to the corresponding nozzle 262.

Although the immediately foregoing description has been directed to structures used primarily in batch type cleaning apparatuses, the principles disclosed therein are equally applicable to a single wafer cleaning apparatus. For instance, a cleaning solution supply member having a buffer tank and/or a plurality of electric-field forming members can also be incorporated into the single wafer type cleaning apparatus of FIG. 1.

In addition, although the nozzle 262, as described above, is installed on the cleaning chamber 220 in communication with an opening thereof, the nozzle 262 can also be installed in a position where it is dipped into the cleaning solution contained in the cleaning chamber 220. The nozzle 262 may also comprise a rod shaped member having a plurality of spraying holes.

If active species are generated in a cleaning solution by dissolving a chemical solution in deionized water, the active species contained in the cleaning solution are mainly ions. According to the principles of the present invention, however, active species are generated by causing deionized water to flow through a region where an electric field is formed. As a result, the active species contained in the deionized water (cleaning water or solution) include both ions and radicals and the amount of active species is abundant. The cleaning efficiency of the cleaning solution according to the principles of the present invention is therefore significantly better than that obtained from the conventional chemical solution. Also, according to the present invention, contaminants can be removed from the wafer W without the use of the chemical solution. Consequently, environmental pollution can be reduced or prevented and the costs associated with the purchase and disposal of the chemical solution can be avoided.

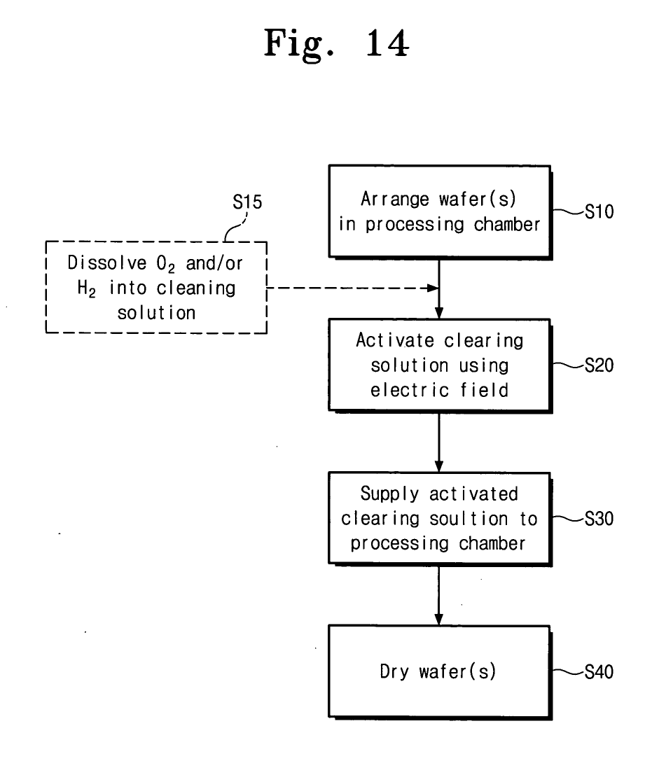

In yet another cleaning apparatus, the active species may be generated by passing one or more gases through a passage where an electric field is formed, and then dissolving the generated active species in the cleaning solution to be supplied to the cleaning chamber. In this apparatus, however, the time between generating the active species and supplying them to the cleaning chamber may be excessive, and the active species may therefore be subject to recombination. According to preferred aspects of the present invention, however, the electric field can be formed in a passage through which the deionized water is supplied, and the active species can thereby be generated directly from the deionized water. The deionized water can then shortly thereafter or immediately be supplied to the cleaning chambers 120, 220. In this manner, recombination of the active species can be minimized. Various methods of cleaning a wafer W using the cleaning apparatuses 10, 20 of the earlier described embodiments will now be explained with additional reference to FIG. 14.

According to one embodiment, a cleaning method is performed to remove contaminants (e.g., metallic contaminants, particles, and/or organic matter) from the wafer W. The method preferably includes using an activated cleaning solution (such as deionized water) to clean the wafer, and drying the wafer W. More specifically, after the wafer or wafers are arranged in a processing chamber, during step S10, a cleaning solution is preferably activated, during step S20, and then supplied to the processing chamber, during step S30. To activate the cleaning solution, an electric field is preferably formed in a region through which the cleaning solution (e.g., deionized water) passes before being supplied to the cleaning chamber 120, 220. In this case, when deionized water flows through the region where the electric field is formed, the water molecules are electrically dissociated into a large quantity of active species, such as ions and radicals. The activated deionized water is then supplied to the cleaning chamber 120, 220 to remove contaminants from the wafer W.

Optionally, in step S15, oxygen gas (O₂) or hydrogen gas (H₂) may be dissolved in the deionized water to generate a large amount of specific desired active species, depending on the type of contaminants to be removed from the wafer W. For example, when the contaminants intended to be removed from the wafer W are mainly organic matter, oxygen gas (O₂) is preferably dissolved in the deionized water. When the contaminants are mainly particles or metal, however, hydrogen gas (H₂) is preferably dissolved in the deionized water. The dissolution of the gas(es) into the deionized water is preferably achieved before the deionized water passes through the region where the electric field is formed.

After cleaning the wafer (W) using the deionized water containing the active species, the wafer W can be dried during step S40. Drying of the wafer W may be accomplished using any one or more of various methods. For instance, the wafer W can be dried using a centrifugal force, a marangoni principle, an azeotropic effect, an isopropyl alcohol vapor, a heated nitrogen gas, or using any other desirable method.

Conventionally, cleaning a wafer W includes a chemical-solution treatment process (in which a chemical solution is used to remove contaminants from the wafer W), a rinsing process (wherein any remaining chemical solution is removed from the wafer W using deionized water), and a drying process (during which the deionized water is removed from the wafer W). According to principles of the present invention, a cleaning process for removing contaminants from the wafer W can be achieved using deionized water containing a large amount of active species, without the need for a chemical solution. The process of rinsing the wafer W is therefore unnecessary. Consequently, the time necessary to perform the cleaning process can be dramatically reduced. In addition, since the deionized water is activated by electric energy, the active species participating in the cleaning process include radicals with excellent reactivity, as well as ions. Therefore, compared with the conventional cleaning method, the cleaning efficiency of the method according to the principles of the present invention is very high. Further, environmental pollution resulting from the use of the chemical solution can be prevented.

Although in the above-described embodiment no rinsing process is performed, in an alternative embodiment, the wafer W may be rinsed using a cleaning solution such as deionized water before drying the wafer W.

In yet another embodiment, the cleaning process can include removing contaminants from the wafer W using a chemical solution, rinsing the wafer W using activated deionized water, and drying the wafer W. As explained previously, the deionized water can have hydrogen (H₂) gas dissolved therein to provide a large amount of hydrogen radicals. This activated deionized water can then be provided to the region where the electric field is formed. Since the method of activating the deionized water is substantially similar to that of the previously-described embodiments, a detailed description thereof will be omitted.

When using a chemical solution, however, fluorine may be combined on the surface of the wafer W. When fluorine combined on the surface of the wafer W is exposed to air, it is replaced with oxygen more easily than hydrogen. It is therefore preferable for hydrogen, rather than fluorine, to be combined on the surface of the wafer in order to prevent the formation of a natural oxide layer on the wafer.

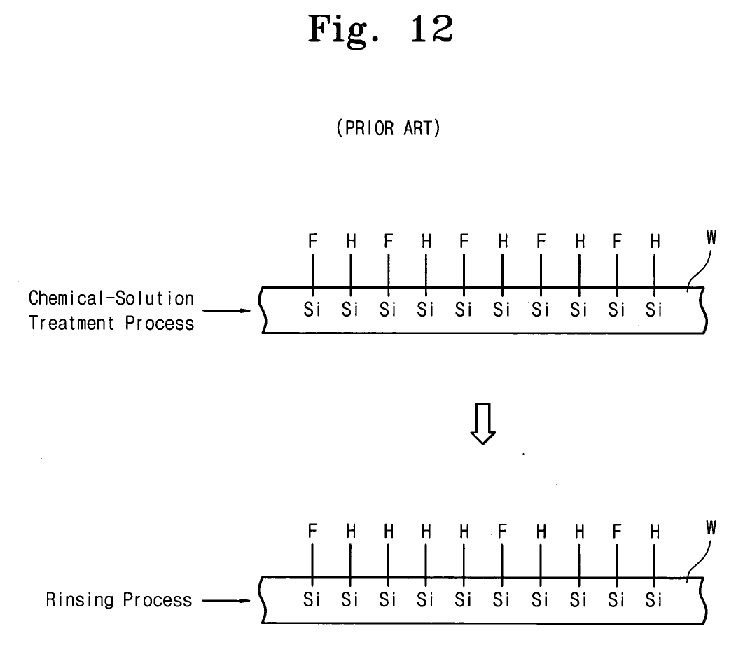

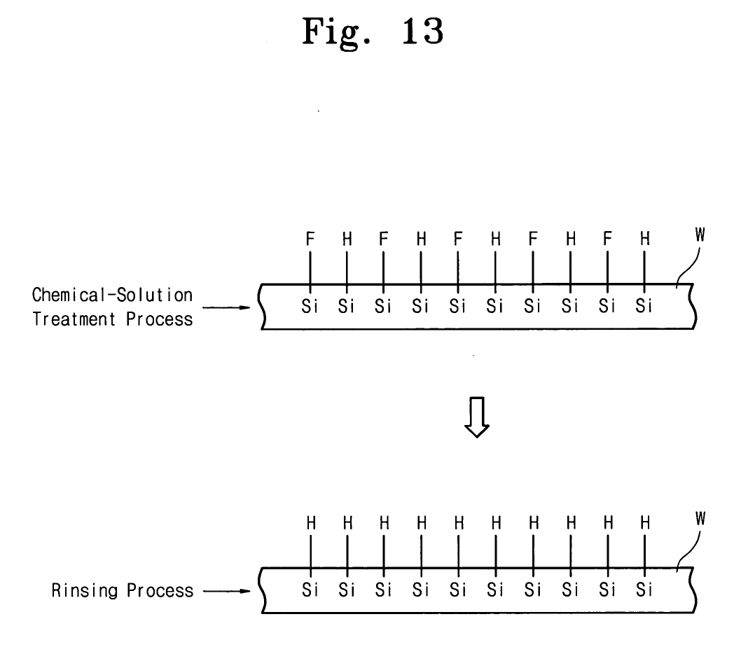

FIG. 12 illustrates a surface state of a wafer W during a conventional cleaning process, which uses general deionized water. FIG. 13 illustrates a surface state of a wafer W during a cleaning process according to principles of the present invention, in which deionized water containing radicals is used. Referring to FIG. 12, when a chemical-solution treatment process is performed using a fluoric acid on a bare wafer, mainly fluorine and hydrogen are combined on the surface of the wafer W. Fluorine is thereafter replaced with hydrogen on the surface of the wafer W by rinsing the wafer W using general deionized water. However, since this replacement is achieved by hydrogen ions, the replacement rate is low and a large amount of fluorine typically remains combined on the surface of the wafer W even after the rinsing process.

Referred to FIG. 13, however, if as taught by principles of the present invention, the wafer W chemically processed by the fluoric acid is rinsed using deionized water containing hydrogen radicals, most of fluorine combined on the surface of the wafer W can be replaced with hydrogen. This is due to the excellent reactivity of the hydrogen radicals. Therefore, even if the wafer W is exposed to oxygen, it is possible to prevent the formation of a natural oxide layer on the wafer W.

The following table (Table 1) presents a comparison of the amount of hydrogen combined on the surface of a bare wafer when the bare wafer is rinsed using deionized water containing no radicals and when the bare wafer is rinsed using deionized water containing radicals. The number representative of the silicon-hydrogen (Si—H) combination was obtained using the variation of wavelengths absorbed by the Si—H combination when the surface of the wafer W is irradiated with infrared rays.

TABLE 1

| | Deionized water | |
|---|---|---|
| | containing radicals | Deionized water |
| Si—H combination | 0.016 | 0.009 |
| (relative magnitude) | | |

As can be seen from Table 1, the number representative of the Si—H combination on the surface of the wafer when the bare wafer is rinsed using deionized water containing radicals is about 1.8 times the number of Si—H combination on the surface of the wafer when the bare wafer is rinsed using the deionized water containing no radicals. The state of Si—H combination on the wafer surface is therefore significantly improved by using activated deionized water containing radicals, as taught by the present invention.

According to certain principles of the present invention, since contaminants can be removed from the wafer using the active species generated from the deionized water, environmental pollution caused by the use of a chemical solution can be prevented. It is also therefore possible to reduce the cost of the overall process by eliminating the costs associated with the purchase and disposal of the chemical solution. In addition, the rinsing process that is inevitably required when a chemical solution is used can be omitted and, consequently, the amount of time necessary to perform the cleaning processes can be reduced. Furthermore, since the deionized water is activated by causing it to flow through a region where an electric field is formed, in addition to ions, a large number of radicals having excellent reactivity can be generated, thereby remarkably improving the cleaning efficiency. And also, since the electric field is preferably formed directly within the cleaning solution supply pipe, the deionized water can be activated just before it is supplied to the cleaning chamber. It is therefore possible to minimize the recombination of the active species before the active species are supplied to the cleaning chamber.

It will be apparent to those skilled in the art that various modifications and variations can be made to the embodiments disclosed herein without departing from the principles of the present invention. Thus, the present invention is intended to cover all such modifications and variations that come within the spirit and scope of the appended claims and their equivalents.

What is claimed is:

1. An apparatus for treating a substrate, comprising:
a processing chamber capable of receiving at least one substrate and configured to perform one or more processes on the substrate using a processing solution; and
an electric-field forming member configured to activate the processing solution by forming an electric field in a passage through which the processing solution flows.

2. The apparatus of claim 1, wherein the electric-field forming member comprises:
a first electrode;
a second electrode disposed apart from the first electrode, wherein the processing solution flows through a space formed between the first electrode and the second electrode; and
a power source configured to supply a predetermined voltage to the first electrode or the second electrode to form an electric-field in the space.

3. The apparatus of claim 2, further comprising:
a processing solution supply member configured to supplying the processing solution to the processing chamber, wherein the processing solution supply member comprises a processing solution supply pipe for supplying the processing solution to the processing chamber;
wherein the first electrode encloses at least a portion of the processing solution supply pipe; and
wherein the second electrode is disposed inside the processing solution supply pipe.

4. The apparatus of claim 3, wherein the processing solution supply pipe comprises an insulating material, and wherein the second electrode is surrounded by an insulator.

5. The apparatus of claim 3, wherein the first electrode comprises a substantially cylindrically-shaped member, and wherein the second electrode comprises a substantially rod-like member.

6. The apparatus of claim 3, wherein the processing solution supply member further comprises a buffer tank installed in communication with the processing solution supply pipe, wherein the buffer tank is adapted to store a quantity of the processing solution after it has been activated by the electric-field forming member.

7. The apparatus of claim 3, further comprising a plurality of processing solution supply pipes installed in parallel, wherein each of the processing solution supply pipes comprises an electric-field forming member installed therein.

8. The apparatus of claim 3, wherein the electric-field forming member is installed in the processing solution supply pipe at a position near the processing chamber.

9. An apparatus for cleaning a substrate, comprising:
a cleaning chamber configured to receive at least one substrate and further configured to perform a cleaning process on the substrate;
a cleaning solution supply member configured to supply a cleaning solution to the cleaning chamber; and
an electric-field forming member installed in the cleaning solution supply member and configured to activate the cleaning solution by forming an electric field in a passage through which the cleaning solution flows.

10. The apparatus of claim 9, wherein the cleaning solution is a deionized water and wherein the activated cleaning solution comprises both radicals and ions to improve a cleaning efficiency of the cleaning solution.

11. The apparatus of claim 10, wherein at least one of hydrogen (H₂) and oxygen (O₂) is dissolved in the deionized water.

12. The apparatus of claim 9, wherein the cleaning solution supply member comprises a cleaning solution supply pipe for supplying the cleaning solution to the cleaning chamber; and
wherein the electric-field forming member comprises a first electrode disposed to enclose at least a portion of the cleaning solution supply pipe, a second electrode disposed inside the cleaning solution supply pipe, and a power source supplying a predetermined voltage to the first electrode or the second electrode.

13. The apparatus of claim 12, wherein the cleaning solution supply pipe is formed of an insulating material, and wherein the second electrode is surrounded by an insulator to prevent the second electrode from being exposed to the cleaning solution.

14. The apparatus of claim 12, wherein the first electrode has a cylindrical shape, and the second electrode has a rod shape.

15. The apparatus of claim 12, wherein the cleaning solution supply member further comprises a buffer tank installed in the cleaning solution supply pipe, wherein the buffer tank stores cleaning solution activated by the electric-field forming member.

16. The apparatus of claim 15, wherein the cleaning chamber comprises a support member having a plurality of slots, each slot configured to receive an edge of a corresponding substrate, such that a plurality of substrates can be simultaneously supported by the support member.

17. The apparatus of claim 12, further comprising a plurality of processing solution supply pipes installed in parallel, wherein each of the processing supply pipes comprises a corresponding electric-field forming member installed therein.

18. The apparatus of claim 17, wherein the cleaning chamber comprises a support member having a plurality of slots, each slot configured to receive an edge of a corresponding substrate, such that a plurality of substrates can be simultaneously supported by the support member.

19. The apparatus of claim 9, wherein the cleaning solution supply member comprises a nozzle for supplying the cleaning solution to the cleaning chamber; and
wherein the electric-field forming member comprises a first electrode disposed to enclose at least a portion of the nozzle and formed in a substantially cylindrical shape, a second electrode disposed inside the nozzle and formed in a substantially rod shape, and a power source configured to supply a predetermined voltage to the first electrode or the second electrode.

20. The apparatus of claim 12, wherein the cleaning solution supply member further comprises a nozzle for receiving the cleaning solution from the cleaning solution supply pipe and for supplying the cleaning solution to the cleaning chamber; and wherein the electric-field forming member is installed in the cleaning solution supply pipe at a position proximal to the nozzle.

21. The apparatus of claim 9, wherein the cleaning chamber comprises a rotatable support member configured to support the substrate such that a surface to be processed faces upward.

22. A method for cleaning a substrate, comprising:
activating a cleaning solution to generate radicals and ions in the cleaning solution by forming an electric field in a passage through which the cleaning solution flows;
supplying the activated cleaning solution to a cleaning chamber configured to receive one or more substrates; and
cleaning the one or more substrates with the radicals and ions contained in the cleaning solution.

23. The method of claim 21, wherein the cleaning solution is a deionized water.

24. The method of claim 22, further comprising dissolving at least one of hydrogen (H₂) and oxygen (O₂) in the deionized water before activating the deionized water.

25. The method of claim 23, wherein the cleaning solution is activated inside a nozzle that supplies the cleaning solution to the cleaning chamber.

26. The method of claim 23, wherein the cleaning solution is activated in a position of the cleaning solution supply pipe adjacent to the nozzle.

27. The method of claim 23, wherein cleaning the wafer with the radicals and ions contained in the cleaning solution comprises removing from the substrate contaminants comprising at least one of: particles; organic matter; and metallic contaminants.

28. The method of claim 27, further comprising drying the substrate after cleaning the substrate using the activated cleaning solution, without performing a rinsing process.

29. The method of claim 22, wherein cleaning the substrate with the radicals and ions contained in the cleaning solution is performed to rinse the substrate from which at least one of metallic contaminants, particles, and organic matter have been removed using a chemical solution.

30. The method of claim 24, further comprising storing the activated cleaning solution in a buffer tank before supplying the activated cleaning solution to the cleaning chamber.

31. The method of claim 24, wherein the cleaning solution is supplied to the cleaning chamber through a plurality of cleaning solution supply members and wherein the cleaning solution is activated in each of the respective cleaning solution supply members.
